(19) United States
(12) Patent Application Publication
(10) Pub. No.: US 2026/0290941 A1
(43) Pub. Date: Sep. 24, 2026

(54) BATTERY MODULE

(71) Applicant: Cheng Uei Precision Industry Co., Ltd., New Taipei City (TW)

(72) Inventors: Min Yu Wu, New Taipei City (TW); Ta Chang Yang, New Taipei City (TW)

(73) Assignee: Cheng Uei Precision Industry Co., Ltd., New Taipei City (TW)

(21) Appl. No.: 19/294,472

(22) Filed: Aug. 8, 2025

(30) Foreign Application Priority Data
Mar. 21, 2025 (CN) 202520517216.9

(51) Int. Cl. H01M 10/6566; H01M 10/613; H01M 10/6563; H01M 50/244; H01M 50/204

(52) U.S. Cl. CPC H01M 10/6566; H01M 10/613; H01M 10/6563; H01M 50/244; H01M 50/204

(57) ABSTRACT

A battery module includes a plurality of battery cells, a frame receiving the plurality of the battery cells, a fan and a shell. The frame has a front wall and two lateral walls. Two opposite sides of a front surface of the front wall are recessed rearward to form two concave portions. A middle of the front surface of the front wall protrudes outward to form a convex portion between the two concave portions. A plurality of air inlet holes penetrate through the two concave portions. The two lateral walls are recessed inward to form two air outlet holes. The plurality of the air inlet holes are communicated with the two air outlet holes. The fan is disposed to a front of the front wall of the frame. The plurality of the battery cells, the frame and the fan are disposed in the shell.

### CROSS REFERENCE TO RELATED APPLICATIONS

The present application is based on, and claims priority from, China Patent Application No. 202520517216.9, filed Mar. 21, 2025, the disclosure of which is hereby incorporated by reference herein in its entirety.

### BACKGROUND OF THE INVENTION

### Field of the Invention

The present invention generally relates to a battery module, and more particularly to a battery module which is capable of improving a heat dissipation effect.

### Description of Related Art

In a high-energy lithium battery cell module system, battery cells are easily affected by external factors to cause an instability to be exploded. The external factors are heat, an impact, and a collision, etc. Because the battery cells are tightly stacked, when one battery cell is thermally runaway, a battery cell module causes a complete overburning situation. A generated heat energy may cause an uncontrollable chain reaction, all the battery cells of the battery cell module are burnt out to cause a damage, and an explosion is even caused to cause an accident.

A conventional heat dissipation structure of the battery module includes a button module, a base plate, an outer shell, a pair of blocking plates, a fan and a pair of fastening end plates. The base plate is disposed to a bottom of the button module. The outer shell is disposed to an outer surface of the button module. The pair of the blocking plates are fastened to two opposite ends of the outer shell. The pair of the fastening end plates are disposed to one sides of the pair of the blocking plates which are close to the base plate and are deviated from the battery module. The fan is fastened to one blocking plate. The fan is deviated from the battery module. The fan has a lower frame. Each blocking plate defines an opening portion penetrates through a front surface and a rear surface of the blocking plate. The lower frame is cooperated with the opening portion. The opening portion has a bottom edge, a top edge opposite to the bottom edge, and two side edges. The two side edges are connected with the bottom edge and the top edge. Several portions of the bottom edge and the two side edges extend outward to form a plurality of buckling hooks perpendicular to the pair of the blocking plates. The plurality of the buckling hooks are deviated from the battery module. The lower frame of the fan is buckled with the plurality of the buckling hooks. The top edge has a pair of clasps. One ends of the pair of the clasps are flush with the top edge. The pair of the clasps perpendicularly extend outward to form a pair of flanges deviated from the battery module. The lower frame of the fan abuts against flanges of the pair of the clasps.

However, when the above-mentioned battery module is charged or discharged, the conventional battery module heat dissipation structure generates the heat energy. A heat dissipation equipment of the conventional battery module heat dissipation structure is insufficient to effectively cool a battery, so a temperature rises, a battery performance is reduced, a usage lifespan of the battery is shortened, and safety issues are even caused.

Thus, it is essential to provide an innovative battery module, and the battery module which is capable of improving a heat dissipation effect.

### BRIEF SUMMARY OF THE INVENTION

An object of the present invention is to provide a battery module which is capable of improving a heat dissipation effect. The battery module includes a plurality of battery cells, a frame receiving the plurality of the battery cells, a fan and a shell. The frame has a front wall, and two lateral walls disposed to two opposite sides of the front wall. Two opposite sides of a front surface of the front wall are recessed rearward to form two concave portions. A middle of the front surface of the front wall protrudes outward to form a convex portion. The convex portion is formed between the two concave portions. A plurality of air inlet holes penetrate through fronts and rears of the two concave portions. Several portions of at least one side of each concave portion extend frontward to form a plurality of flow guiding ribs. The plurality of the air inlet holes are disposed among the plurality of the flow guiding ribs. Outer surfaces of the two lateral walls are recessed inward to form two air outlet holes. The plurality of the air inlet holes are communicated with the two air outlet holes. The fan is disposed to a front of the front wall of the frame. The plurality of the battery cells, the frame and the fan are disposed in the shell.

Another object of the present invention is to provide a battery module. The battery module includes a shell, a fan disposed in the shell, a frame disposed in the shell, a plurality of battery cells and a circuit board. The frame has a front wall, and two lateral walls disposed to two opposite sides of the front wall. The front wall is corresponding to the fan. Two opposite sides of a front surface of the front wall are recessed rearward to form two concave portions. A middle of the front surface of the front wall protrudes outward to form a convex portion. The convex portion is formed between the two concave portions. A plurality of air inlet holes penetrate through fronts and rears of the two concave portions. Several portions of at least one side of each concave portion extend frontward to form a plurality of flow guiding ribs. The plurality of the air inlet holes are disposed among the plurality of the flow guiding ribs. Outer surfaces of the two lateral walls are recessed inward to form two air outlet holes. The two air outlet holes are disposed to rears of the plurality of the air inlet holes. The plurality of the air inlet holes are communicated with the two air outlet holes. An assembling space is formed between one lateral wall of the frame and one side of the shell. One air outlet hole is communicated with the assembling space. The plurality of the battery cells are disposed in the frame. The circuit board is disposed in the assembling space.

Another object of the present invention is to provide a battery module. The battery module includes a shell, a fan disposed in the shell, a frame disposed in the shell, a plurality of battery cells and a circuit board. The frame has a front wall, and two lateral walls disposed to two opposite sides of the front wall. The front wall is corresponding to the fan. Two opposite sides of a front surface of the front wall are recessed rearward to form two concave portions. A middle of the front surface of the front wall protrudes outward to form a convex portion. The convex portion is formed between the two concave portions. Each concave portion has a first arc portion, a second arc portion and a panel. A junction between each concave portion and the convex portion is gradually recessed inward and rearward to form the first arc portion. The two first arc portions of the two concave portions are formed at the two opposite sides of the convex portion. The two first arc portions are connected with the convex portion. A junction between an outer side of each concave portion and an outer edge of the front wall is gradually recessed inward and rearward to form the second arc portion. The panel is disposed between the first arc portion and the second arc portion. The first arc portion and the second arc portion are disposed to two opposite sides of the panel, respectively. A plurality of air inlet holes penetrate through front surfaces and rear surfaces of the two panels of the two concave portions. Several portions of the two first arc portions and one second arc portion of the two concave portions extend frontward to form a plurality of flow guiding ribs. Several portions of the other second arc portion of the two concave portions extend frontward to form a plurality of locking portions. The plurality of the locking portions extend beyond the front wall. The plurality of the air inlet holes are disposed among the plurality of the flow guiding ribs. Outer surfaces of the two lateral walls are recessed inward to form two air outlet holes. The two air outlet holes are disposed to rears of the plurality of the air inlet holes. The plurality of the air inlet holes are communicated with the two air outlet holes. An assembling space is formed between one lateral wall of the frame and one side of the shell. One air outlet hole is communicated with the assembling space. The plurality of the battery cells are disposed in the frame. The circuit board is disposed in the assembling space. The circuit board and the plurality of the locking portions are oppositely disposed to the two lateral walls, respectively.

As described above, the battery module has an innovative structure design, the two opposite sides of the front surface of the front wall are recessed rearward to form the two concave portions, and the two concave portions are used for concentrating an air volume. The convex portion is formed between the two concave portions. The two concave portions are formed at the two opposite sides of the convex portion. The convex portion is used for reinforcing a structural strength of the frame. Each concave portion has the first arc portion, the second arc portion and the panel. Several portions of the two first arc portions and the one second arc portion of the two concave portions extend frontward to form the plurality of the flow guiding ribs. The plurality of the flow guiding ribs are used for concentrating the air volume and guiding an airflow. The plurality of the air inlet holes penetrate through the front surfaces and the rear surfaces of the two panels of the two concave portions. The plurality of the air inlet holes are disposed among the plurality of the flow guiding ribs. An aperture of a front end of each air inlet hole is bigger than an aperture of a rear end of each air inlet hole. The plurality of the air inlet holes concentrate the air volume by the apertures of the plurality of the air inlet holes, and the aperture of each air inlet hole gradually becomes smaller from front to rear, so the plurality of the air inlet holes enhance an exhaust effect and a heat dissipation effect. Furthermore, each air outlet hole is shown as a trapezoidal structure, and a front surface of each air outlet hole is wider than a rear surface of each air outlet hole, so the two air outlet holes enhance the exhaust effect and the heat dissipation effect. The one air outlet hole is communicated with the assembling space. A wind enters the plurality of the air inlet holes. The wind is led to the assembling space by the two air outlet holes, so the circuit board has the better heat dissipation effect. As a result, the battery module is capable of improving the heat dissipation effect.

### BRIEF DESCRIPTION OF THE DRAWINGS

The present invention will be apparent to those skilled in the art by reading the following description, with reference to the attached drawings, in which:

FIG. 1 is a perspective view of a battery module in accordance with a preferred embodiment of the present invention;

FIG. 2 is a another perspective view of the battery module;

FIG. 3 is partially perspective view of the battery module of FIG. 1;

FIG. 4 is an enlarged view of an encircled portion X1 of the battery module of FIG. 3

FIG. 5 is a diagrammatic drawing of a frame of the battery module of FIG. 1;

FIG. 6 is a sectional diagram of the battery module along a line VI-VI of FIG. 5;

FIG. 7 is a diagrammatic drawing of the battery module of FIG. 1;

FIG. 8 is a sectional diagram of the battery module along a line VIII-VIII of FIG. 7.

### DETAILED DESCRIPTION OF THE INVENTION

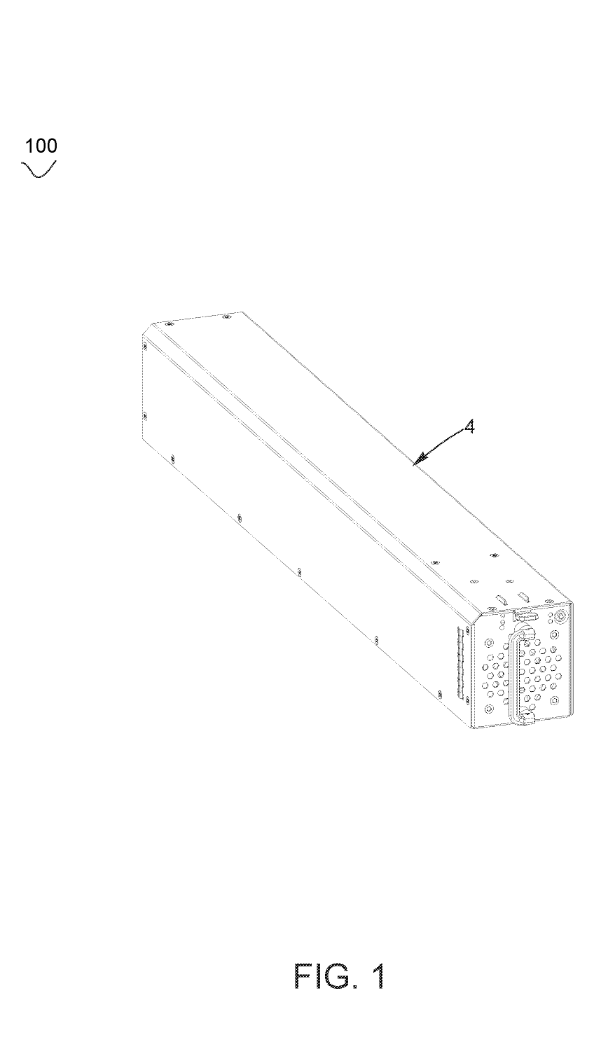

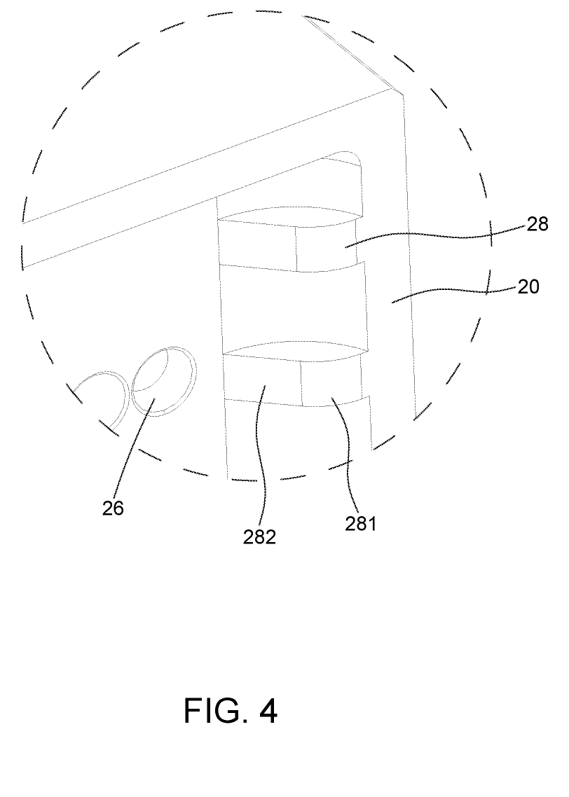

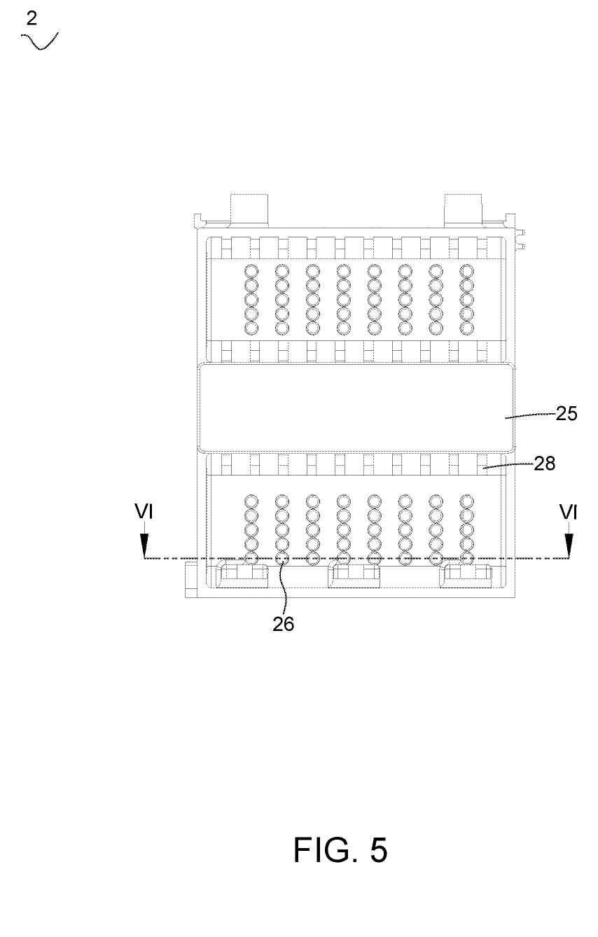

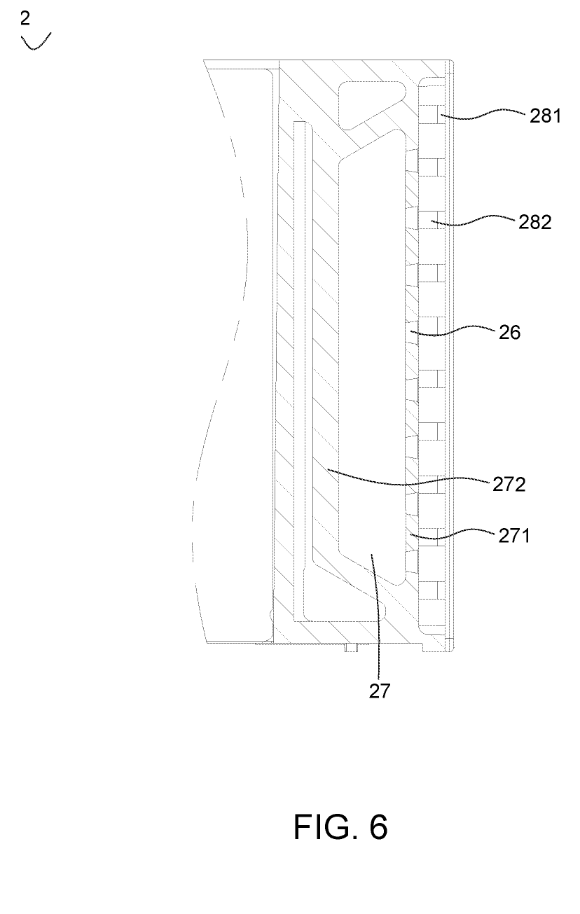

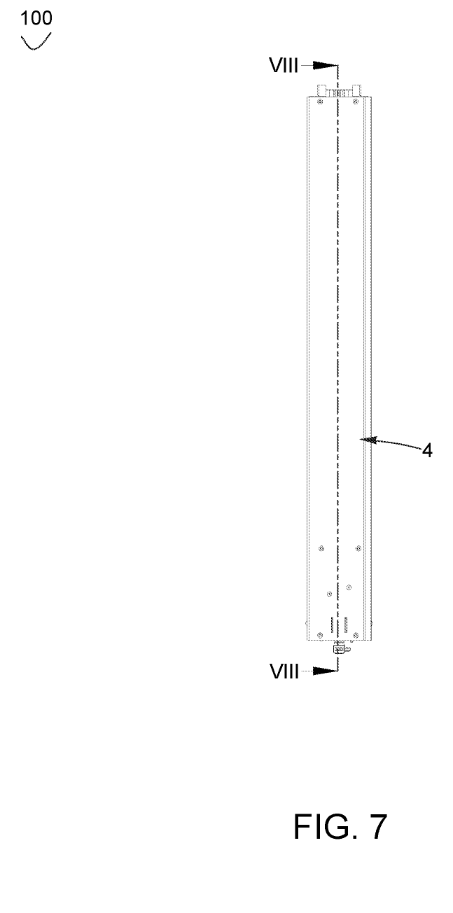

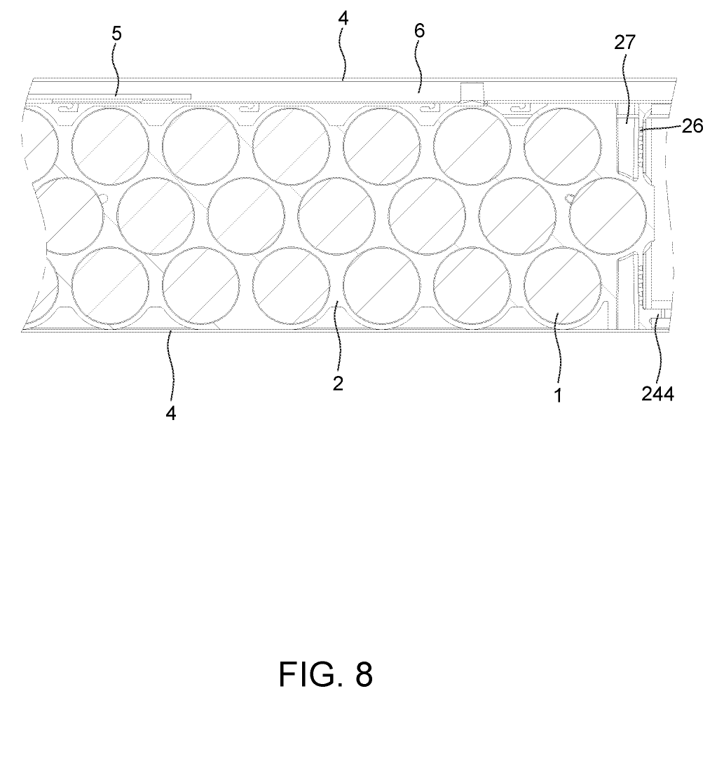

With reference to FIGS. 1 to 8, a battery module 100 according to a preferred embodiment of the present invention is shown. The battery module 100 includes a plurality of battery cells 1, a frame 2 receiving the plurality of the battery cells 1, a fan 3, a shell 4 and a circuit board 5.

The plurality of the battery cells 1 are disposed in the frame 2. The fan 3 is disposed to a front end of the frame 2. The plurality of the battery cells 1, the frame 2, the fan 3 and the circuit board 5 are disposed in the shell 4. An assembling space 6 is formed between one side of the shell 4 and one side of the frame 2. The circuit board 5 is disposed in the assembling space 6. The other side of the shell 4 is connected with the other side of the frame 2.

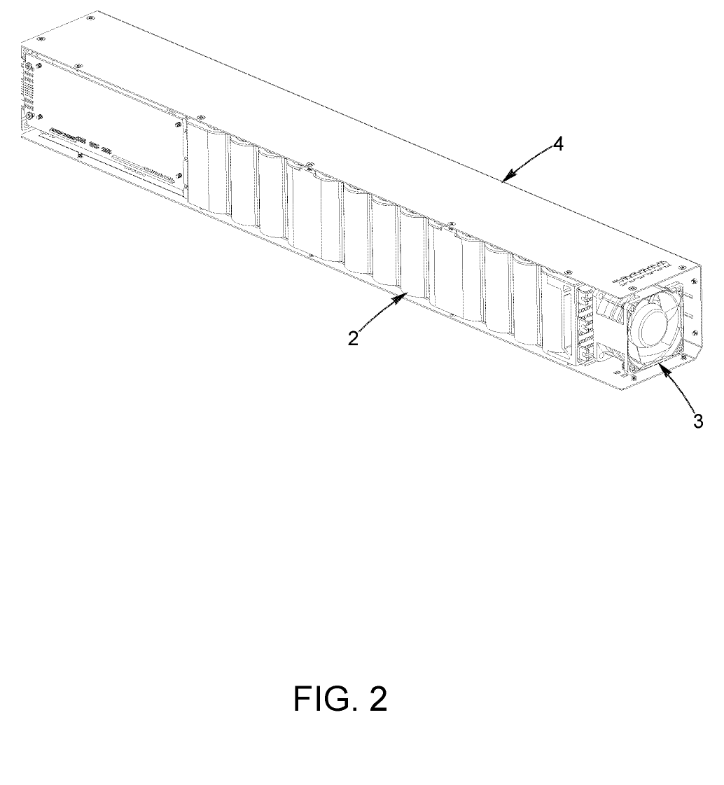

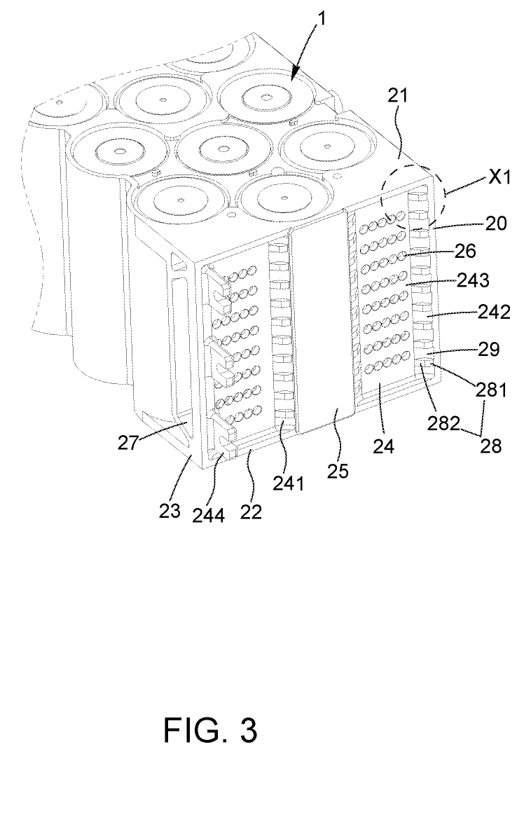

Referring to FIGS. 2 and 3, the frame 2 has a front wall 20, a top wall 21, a bottom wall 22, two lateral walls 23 disposed to two opposite sides of the front wall 20, two concave portions 24, a convex portion 25, a plurality of air inlet holes 26, two air outlet holes 27, a plurality of flow guiding ribs 28 and a plurality of arc grooves 29. The front wall 20 is disposed to a front end of the top wall 21 and a front end of the bottom wall 22. The two lateral walls 23 are disposed to two sides of the top wall 21 and two sides of the bottom wall 22, respectively. The two lateral walls 23 are connected between the top wall 21 and the bottom wall 22. The front wall 20 is corresponding to the fan 3. The fan 3 is disposed to a front of the front wall 20 of the frame 2. The assembling space 6 is formed between one lateral wall 23 of the frame 2 and the one side of the shell 4. The other lateral wall 23 of the frame 2 is connected to the shell 4.

Two opposite sides of a front surface of the front wall 20 are recessed rearward to form the two concave portions 24. The two concave portions 24 are used for concentrating an air volume. A middle of the front surface of the front wall 20 of the frame 2 protrudes outward to form the convex portion 25. The convex portion 25 is formed between the two concave portions 24. The two concave portions 24 are formed at two opposite sides of the convex portion 25. The convex portion 25 is used for reinforcing a structural strength of the frame 2.

Each concave portion 24 has a first arc portion 241, a second arc portion 242 and a panel 243. A junction between each concave portion 24 and the convex portion 25 is gradually recessed inward and rearward to form a first arc portion 241. Two sides of the first arc portion 241 gradually expand outward. The two first arc portions 241 of the two concave portions 24 are formed at the two opposite sides of the convex portion 25. The two sides of the convex portion 25 are recessed inward and rearward to form the two first arc portions 241. The two first arc portions 241 extend into the two concave portions 24. Two sides of the middle of the front surface of the front wall 20 of the frame 2 are recessed inward and rearward to form the two first arc portions 241. The two first arc portions 241 are connected with the convex portion 25.

A junction between an outer side of each concave portion 24 and an outer edge of the front wall 20 is gradually recessed inward and rearward to form a second arc portion 242. An outer side of the second arc portion 242 expands outward, and an inner side of the second arc portion 242 extends inward. Two opposite outer edges of the front wall 20 are gradually recessed inward and rearward to form the two second arc portions 242. An extending direction of each first arc portion 241 is opposite to an extending direction of each second arc portion 242. The panel 243 is disposed between the first arc portion 241 and the second arc portion 242. The first arc portion 241 and the second arc portion 242 are disposed to two opposite sides of the panel 243, respectively.

Referring to FIGS. 3 to 5, the plurality of the air inlet holes 26 penetrate through fronts and rears of the two concave portions 24. The plurality of the air inlet holes 26 penetrate through front surfaces and rear surfaces of the two panels 243 of the two concave portions 24. In the preferred embodiment, the plurality of the air inlet holes 26 are conical structures. The plurality of the air inlet holes 26 are able to collect more air volume. An aperture of a front end of each air inlet hole 26 is bigger than an aperture of a rear end of each air inlet hole 26. The plurality of the air inlet holes 26 concentrate the air volume by apertures of the plurality of the air inlet holes 26. The aperture of each air inlet hole 26 gradually becomes smaller from front to rear, so the plurality of the air inlet holes 26 concentrate the air volume, the plurality of the air inlet holes 26 enhance an exhaust effect and a heat dissipation effect.

Referring to FIGS. 3 to 7, outer surfaces of the two lateral walls 23 of the frame 2 are recessed inward to form the two air outlet holes 27. The two air outlet holes 27 are disposed to rears of the plurality of the air inlet holes 26. The plurality of the air inlet holes 26 are communicated with the two air outlet holes 27. The two air outlet holes 27 are used for concentrating the air volume and guiding an airflow. In the preferred embodiment, one air outlet hole 27 is communicated with the assembling space 6. In the preferred embodiment, a wind enters the plurality of the air inlet holes 26. The wind is led to the assembling space 6 by the two air outlet holes 27, so the circuit board 5 has the better heat dissipation effect.

Each air outlet hole 27 has a front surface 271 and a rear surface 272. The plurality of the air inlet holes 26 longitudinally penetrate through the panel 243 and the front surface 271 of the two air outlet holes 27. In the preferred embodiment, each air outlet hole 27 is shown as a trapezoidal structure. A front end of each air outlet hole 27 is wider than a rear end of each air outlet hole 27. The front surface 271 of each air outlet hole 27 is wider than the rear surface 272 of each air outlet hole 27, so the two air outlet holes 27 enhance the exhaust effect and the heat dissipation effect.

Several portions of at least one side of each concave portion 24 extend frontward to form the plurality of the flow guiding ribs 28. Several portions of the two first arc portions 241 and one second arc portion 242 of the two concave portions 24 extend frontward to form the plurality of the flow guiding ribs 28. The plurality of the air inlet holes 26 are disposed among the plurality of the flow guiding ribs 28. The plurality of the flow guiding ribs 28 are used for concentrating the air volume and guiding the airflow.

Several portions of the other second arc portion 242 of the two concave portions 24 extend frontward to form a plurality of locking portions 244. The plurality of the locking portions 244 extend beyond the front wall 20 of the frame 2. In the preferred embodiment, the circuit board 5 and the plurality of the locking portions 244 are oppositely disposed to the two lateral walls 23 of the frame 2, respectively. The frame 2 is secured to the shell 4 by the plurality of the locking portions 244.

Referring to FIGS. 3 to 8, in the preferred embodiment, each flow guiding rib 28 has a curve portion 281 and an inclining portion 282. A front end of each flow guiding rib 28 is defined as the curve portion 281. A rear end of each flow guiding rib 28 is defined as the inclining portion 282. Front ends of the plurality of the curve portions 281 of the two first arc portions 241 of the two concave portions 24 are connected with the convex portion 25. The front ends of the plurality of the curve portions 281 of the one second arc portion 242 of the two concave portions 24 are connected with one outer edge of the front wall 20. A rear end of the curve portion 281 extends rearward to form the inclining portion 282. One sides of the plurality of the inclining portions 282 of the plurality of the flow guiding ribs 28 obliquely extend into the two concave portions 24. Rear ends of the plurality of the inclining portions 282 of the plurality of the flow guiding ribs 28 are connected with the two panels 243 of the two concave portions 24.

Specifically, several portions of one side surfaces of the two first arc portions 241 of the two concave portions 24 are arched frontward to form the plurality of the curve portions 281 of the plurality of the flow guiding ribs 28. The plurality of the curve portions 281 of the two first arc portions 241 of the two concave portions 24 are close to the convex portion 25. Rear surfaces of the two first arc portions 241 of the two concave portions 24 extend frontward to form the plurality of the inclining portions 282 of the plurality of the flow guiding ribs 28. One sides of the plurality of the inclining portions 282 slantwise extend frontward and sideward. The plurality of the inclining portions 282 of the two first arc portions 241 and the one second arc portion 242 of the two concave portions 24 are close to the two panels 243 of the two concave portions 24. The plurality of the curve portions 281 are connected with the plurality of the inclining portions 282.

The two first arc portions 241 and the one second arc portion 242 have the plurality of the arc grooves 29. Each arc groove 29 of the two first arc portions 241 is formed between two adjacent flow guiding ribs 28 and an inner surface of one first arc portion 241. Each arc groove 29 of the one second arc portion 242 is formed between the two adjacent flow guiding ribs 28 and the one second arc portion 242. Each arc groove 29 is gradually recessed rearward and inward. The plurality of the arc grooves 29 are used for concentrating the air volume and guiding the airflow.

As described above, the battery module 100 has an innovative structure design, the two opposite sides of the front surface of the front wall 20 are recessed rearward to form the two concave portions 24, and the two concave portions 24 are used for concentrating the air volume. The convex portion 25 is formed between the two concave portions 24. The two concave portions 24 are formed at the two opposite sides of the convex portion 25. The convex portion 25 is used for reinforcing the structural strength of the frame 2. Each concave portion 24 has the first arc portion 241, the second arc portion 242 and the panel 243. Several portions of the two first arc portions 241 and the one second arc portion 242 of the two concave portions 24 extend frontward to form the plurality of the flow guiding ribs 28. The plurality of the flow guiding ribs 28 are used for concentrating the air volume and guiding the airflow. The plurality of the air inlet holes 26 penetrate through the front surfaces and the rear surfaces of the two panels 243 of the two concave portions 24. The plurality of the air inlet holes 26 are disposed among the plurality of the flow guiding ribs 28. The aperture of the front end of each air inlet hole 26 is bigger than the aperture of the rear end of each air inlet hole 26. The plurality of the air inlet holes 26 concentrate the air volume by the apertures of the plurality of the air inlet holes 26, and the aperture of each air inlet hole 26 gradually becomes smaller from front to rear, so the plurality of the air inlet holes 26 enhance the exhaust effect and the heat dissipation effect. Furthermore, each air outlet hole 27 is shown as the trapezoidal structure, and the front surface 271 of each air outlet hole 27 is wider than the rear surface 272 of each air outlet hole 27, so the two air outlet holes 27 enhance the exhaust effect and the heat dissipation effect. The one air outlet hole 27 is communicated with the assembling space 6. The wind enters the plurality of the air inlet holes 26. The wind is led to the assembling space 6 by the two air outlet holes 27, so the circuit board 5 has the better heat dissipation effect. As a result, the battery module 100 is capable of improving the heat dissipation effect.

What is claimed is:

1. A battery module, comprising:
a plurality of battery cells;
a frame receiving the plurality of the battery cells, the frame having a front wall, and two lateral walls disposed to two opposite sides of the front wall, two opposite sides of a front surface of the front wall being recessed rearward to form two concave portions, a middle of the front surface of the front wall protruding outward to form a convex portion, the convex portion being formed between the two concave portions, a plurality of air inlet holes penetrating through fronts and rears of the two concave portions, several portions of at least one side of each concave portion extending frontward to form a plurality of flow guiding ribs, the plurality of the air inlet holes being disposed among the plurality of the flow guiding ribs, outer surfaces of the two lateral walls being recessed inward to form two air outlet holes, the plurality of the air inlet holes being communicated with the two air outlet holes;
a fan disposed to a front of the front wall of the frame; and
a shell, the plurality of the battery cells, the frame and the fan being disposed in the shell.

2. The battery module as claimed in claim 1, wherein a junction between each concave portion and the convex portion is gradually recessed inward and rearward to form a first arc portion, two sides of the first arc portion gradually expand outward, the two first arc portions of the two concave portions are formed at two opposite sides of the convex portion, the two first arc portions are connected with the convex portion.

3. The battery module as claimed in claim 2, wherein a junction between an outer side of each concave portion and an outer edge of the front wall is gradually recessed inward and rearward to form a second arc portion, an outer side of the second arc portion expands outward, and an inner side of the second arc portion extends inward, an extending direction of each first arc portion is opposite to an extending direction of each second arc portion, several portions of the two first arc portions and one second arc portion of the two concave portions extend frontward to form the plurality of the flow guiding ribs.

4. The battery module as claimed in claim 3, wherein each concave portion has a panel, the panel is disposed between the first arc portion and the second arc portion, the first arc portion and the second arc portion are disposed to two opposite sides of the panel, respectively, the plurality of the air inlet holes penetrate through front surfaces and rear surfaces of the two panels of the two concave portions.

5. The battery module as claimed in claim 4, wherein an aperture of a front end of each air inlet hole is bigger than an aperture of a rear end of each air inlet hole.

6. The battery module as claimed in claim 4, wherein each flow guiding rib has a curve portion and an inclining portion, several portions of one side surfaces of the two first arc portions of the two concave portions are arched frontward to form the plurality of the curve portions of the plurality of the flow guiding ribs, the plurality of the curve portions of the two first arc portions of the two concave portions are close to the convex portion, rear surfaces of the two first arc portions of the two concave portions extend frontward to form the plurality of the inclining portions of the plurality of the flow guiding ribs, the plurality of the inclining portions of the two first arc portions and the one second arc portion of the two concave portions are close to the two panels of the two concave portions, the plurality of the curve portions are connected with the plurality of the inclining portions.

7. The battery module as claimed in claim 4, wherein each air outlet hole has a front surface and a rear surface, the plurality of the air inlet holes longitudinally penetrate through the panel and the front surface of the two air outlet holes, each air outlet hole is shown as a trapezoidal structure, the front surface of each air outlet hole is wider than the rear surface of each air outlet hole.

8. The battery module as claimed in claim 3, wherein the two first arc portions and the one second arc portion have a plurality of arc grooves, each arc groove of the two first arc portions is formed between two adjacent flow guiding ribs and an inner surface of one first arc portion, each arc groove of the one second arc portion is formed between the two adjacent flow guiding ribs and the one second arc portion, each arc groove is gradually recessed rearward and inward.

9. The battery module as claimed in claim 3, wherein several portions of the other second arc portion of the two concave portions extend frontward to form a plurality of locking portions, the plurality of the locking portions extend beyond the front wall of the frame.

10. The battery module as claimed in claim 9, further comprising a circuit board, an assembling space being formed between one side of the shell and one side of the frame, the circuit board being disposed in the assembling space, one air outlet hole being communicated with the assembling space, the circuit board and the plurality of the locking portions being oppositely disposed to the two lateral walls of the frame, respectively, the frame being secured to the shell by the plurality of the locking portions.

11. A battery module, comprising:
a shell;
a fan disposed in the shell;
a frame disposed in the shell, the frame having a front wall, and two lateral walls disposed to two opposite sides of the front wall, the front wall being corresponding to the fan, two opposite sides of a front surface of the front wall being recessed rearward to form two concave portions, a middle of the front surface of the front wall protruding outward to form a convex portion, the convex portion being formed between the two concave portions, a plurality of air inlet holes penetrating through fronts and rears of the two concave portions, several portions of at least one side of each concave portion extending frontward to form a plurality of flow guiding ribs, the plurality of the air inlet holes being disposed among the plurality of the flow guiding ribs, outer surfaces of the two lateral walls being recessed inward to form two air outlet holes, the two air outlet holes being disposed to rears of the plurality of the air inlet holes, the plurality of the air inlet holes being communicated with the two air outlet holes, an assembling space being formed between one lateral wall of the frame and one side of the shell, one air outlet hole being communicated with the assembling space;
a plurality of battery cells disposed in the frame; and
a circuit board disposed in the assembling space.

12. The battery module as claimed in claim 11, wherein a junction between each concave portion and the convex portion is gradually recessed inward and rearward to form a first arc portion, two sides of the first arc portion gradually expand outward, the two first arc portions of the two concave portions are formed at two opposite sides of the convex portion, the two first arc portions are connected with the convex portion.

13. The battery module as claimed in claim 12, wherein a junction between an outer side of each concave portion and an outer edge of the front wall is gradually recessed inward and rearward to form a second arc portion, an outer side of the second arc portion expands outward, and an inner side of the second arc portion extends inward, an extending direction of each first arc portion is opposite to an extending direction of each second arc portion, several portions of the two first arc portions and one second arc portion of the two concave portions extend frontward to form the plurality of the flow guiding ribs.

14. The battery module as claimed in claim 13, wherein each concave portion has a panel, the panel is disposed between the first arc portion and the second arc portion, the first arc portion and the second arc portion are disposed to two opposite sides of the panel, respectively, the plurality of the air inlet holes penetrate through front surfaces and rear surfaces of the two panels of the two concave portions.

15. The battery module as claimed in claim 14, wherein an aperture of a front end of each air inlet hole is bigger than an aperture of a rear end of each air inlet hole.

16. The battery module as claimed in claim 14, wherein each flow guiding rib has a curve portion and an inclining portion, several portions of one side surfaces of the two first arc portions of the two concave portions are arched frontward to form the plurality of the curve portions of the plurality of the flow guiding ribs, the plurality of the curve portions of the two first arc portions of the two concave portions are close to the convex portion, rear surfaces of the two first arc portions of the two concave portions extend frontward to form the plurality of the inclining portions of the plurality of the flow guiding ribs, the plurality of the inclining portions of the two first arc portions and the one second arc portion of the two concave portions are close to the two panels of the two concave portions, the plurality of the curve portions are connected with the plurality of the inclining portions.

17. The battery module as claimed in claim 14, wherein each air outlet hole has a front surface and a rear surface, the plurality of the air inlet holes longitudinally penetrate through the panel and the front surface of the two air outlet holes, each air outlet hole is shown as a trapezoidal structure, the front surface of each air outlet hole is wider than the rear surface of each air outlet hole.

18. The battery module as claimed in claim 13, wherein the two first arc portions and the one second arc portion have a plurality of arc grooves, each arc groove of the two first arc portions is formed between two adjacent flow guiding ribs and an inner surface of one first arc portion, each arc groove of the one second arc portion is formed between the two adjacent flow guiding ribs and the one second arc portion, each arc groove is gradually recessed rearward and inward.

19. The battery module as claimed in claim 13, wherein several portions of the other second arc portion of the two concave portions extend frontward to form a plurality of locking portions, the plurality of the locking portions extend beyond the front wall of the frame.

20. A battery module, comprising:
a shell;
a fan disposed in the shell;
a frame disposed in the shell, the frame having a front wall, and two lateral walls disposed to two opposite sides of the front wall, the front wall being corresponding to the fan, two opposite sides of a front surface of the front wall being recessed rearward to form two concave portions, a middle of the front surface of the front wall protruding outward to form a convex portion, the convex portion being formed between the two concave portions, each concave portion having a first arc portion, a second arc portion and a panel, a junction between each concave portion and the convex portion being gradually recessed inward and rearward to form the first arc portion, the two first arc portions of the two concave portions being formed at the two opposite sides of the convex portion, the two first arc portions being connected with the convex portion, a junction between an outer side of each concave portion and an outer edge of the front wall being gradually recessed inward and rearward to form the second arc portion, the panel being disposed between the first arc portion and the second arc portion, the first arc portion and the second arc portion being disposed to two opposite sides of the panel, respectively, a plurality of air inlet holes penetrating through front surfaces and rear surfaces of the two panels of the two concave portions, several portions of the two first arc portions and one second arc portion of the two concave portions extending frontward to form a plurality of flow guiding ribs, several portions of the other second arc portion of the two concave portions extending frontward to form a plurality of locking portions, the plurality of the locking portions extending beyond the front wall, the plurality of the air inlet holes being disposed among the plurality of the flow guiding ribs, outer surfaces of the two lateral walls being recessed inward to form two air outlet holes, the two air outlet holes being disposed to rears of the plurality of the air inlet holes, the plurality of the air inlet holes being communicated with the two air outlet holes, an assembling space being formed between one lateral wall of the frame and one side of the shell, one air outlet hole being communicated with the assembling space;
a plurality of battery cells disposed in the frame; and
a circuit board disposed in the assembling space, the circuit board and the plurality of the locking portions being oppositely disposed to the two lateral walls, respectively.
